(19) United States
(12) Patent Application Publication
(10) Pub. No.: US 2013/0145605 A1
(43) Pub. Date: Jun. 13, 2013

(54) NUT-HOLDING MEMBER AND BOLT-JOINING METHOD

(71) Applicants: Norihiko Kajimura, Koto-ku (JP); Keita Yamada, Koto-ku (JP); Yuji Suzuki, Koto-ku (JP)

(72) Inventors: Norihiko Kajimura, Koto-ku (JP); Keita Yamada, Koto-ku (JP); Yuji Suzuki, Koto-ku (JP)

(73) Assignee: Nippon Steel & Sumikin Metal Products Co., Ltd., Koto-ku ,Tokyo (JP)

(21) Appl. No.: 13/817,107

(22) PCT Filed: Aug. 19, 2011
(86) PCT No.: PCT/JP2011/068801

§ 371 Date: Feb. 14, 2013

(30) Foreign Application Priority Data
Aug. 25, 2010 (JP) 2010-188452

(51) Int. Cl. F16B 37/04

(52) U.S. Cl. CPC F16B 37/04
USPC 29/525.02; 411/204

(57) ABSTRACT

A nut-holding member for use when bolt-joining a plurality of bases having a bolt hole comprises a nut insertion part for inserting a nut, a stage part, and a stopper part for holding the nut in a dropout prevention state so that the nut inserted in the nut insertion part is kept from dropping out; the stopper part has such a shape as to project to the bearing surface side of the nut inserted in the nut insertion part serving as a surface to be installed on the base or a shape provided with a projection part projecting to the upper surface side of the nut so as to engage a screw groove; and the dropout prevention state of the nut is released by screwing a leading end of the bolt into the nut and thereby deforming the stopper part.

### TECHNICAL FIELD

The present invention relates to a technical field of a nut-holding member for use when bolt-joining bases having a bolt hole and a bolt-joining method.

### BACKGROUND ART

It has conventionally been known that road safety fences constructed by beam pipes, for example, use nut-holding members, since the beam pipes have such small diameters as to keep human hands from being inserted therein and make it difficult or impossible to hold bolt-joining nuts within hollows therein.

For example, a nut-holding member disclosed in the following Patent Literature 1 for use in a road safety fence is one in which, for bolt-joining a joint pipe supported by a pole and a beam pipe to each other, a nut is firmly fixed to a flat plate to which a suction cup is attached; i.e., a structure in which the nut-holding member is inserted into the joint pipe, and the suction cup is attached to the latter by suction, so as to determine the positions of the flat plate and nut, thereby enabling bolt-joining.

A nut-holding member disclosed in the following Patent Literature 2 for use in a road safety fence is one in which, for bolt-joining a joint pipe supported by a pole and a beam pipe to each other, a nut is caulked and secured into a groove of a holding member having a groove-shaped cross section; i.e., a structure in which the nut-holding member is inserted into the joint pipe, the nut and a bolt hole are aligned with each other, and then the nut-holding member is positioned with respect to the joint pipe by riveting or means such as self-tapping screws, so as to perform bolt-joining.

### CITATION LIST

### Patent Literature

Patent Literature 1: Japanese Utility Model Application Laid-Open No. 55-48909

Patent Literature 2: Japanese Utility Model Application Laid-Open No. 2-6717

### SUMMARY OF INVENTION

### Technical Problem

As means for bolt joints in the case where a beam pipe constituting a road safety fence has a hollow with such a small diameter that a human hand cannot be inserted therein or substantially a closed form which makes it difficult or impossible to insert and hold a nut for the bolt joint into the hollow, the above-mentioned Patent Literatures 1 and 2 propose nut-holding member structures conforming to their corresponding bolt-joining conditions.

However, a common problem of the prior art lies in that a nut is firmly fixed or caulked in order to be secured to its corresponding position in the nut-holding member. When firmly secured as mentioned above, the nut becomes totally immovable, so that the leading end of a bolt must be screwed into the nut by manipulating the bolt alone during bolt-joining. While the operation of screwing the leading end of the bolt into the nut is easier when the nut can rotationally move along the axis of the bolt than when manipulating the bolt alone, the bolt-joining operation in the state where the nut is welded to the nut-holding member and totally immovable as mentioned above is not only very troublesome, but also yields variations in the accuracy of construction.

Here, the inventors have found that providing a stopper part for pressing the bearing surface (the surface coming into contact with a base) of the nut is effective in holding the nut without securing it to the nut-holding member. As a result of further trial and error, the inventors have also found the following problem. That is, as the bolt is screwed into the nut held by the nut-holding member provided with the stopper part, the stopper part is finally held between the bolt and nut, which remarkably lowers the accuracy in fixing the bolt and nut to each other, thereby hindering firm fastening.

In short, no nut-holding member, including the one used for road safety fences, has been disclosed yet for preventing the nut from being dropping out, while providing some play without firmly fixing or caulking it, and exhibiting a stable fixing property when bolt-joined and keeping a firmly fastened state.

It is an object of the present invention to solve the problems mentioned above and provide a nut-holding member and bolt-joining method which, by contriving the structure of the nut-holding member accommodating a nut, can efficiently perform an operation for fastening the bolt and nut to each other, prevent the nut from dropping out when installing the nut-holding member, enhance the fixing property between the bolt and nut when bolt-joined, and eternally keep the firmly fastened state.

### Solution to Problem

As means for solving the above-mentioned problems, the nut-holding member is a nut-holding member for use when bolt-joining a plurality of bases having a bolt hole;
the nut-holding member comprising a nut insertion part for inserting a nut therein such that the nut is kept from rotating together with screwing of a bolt, a stage part where an upper surface of the nut located on a side opposite from a bearing surface thereof is seated, and a stopper part for holding the nut in a dropout prevention state so that the nut inserted in the nut insertion part is kept from dropping out;
wherein the stopper part has such a shape as to project to the bearing surface side of the nut inserted in the nut insertion part serving as a surface to be installed on the base or a shape provided with a projection part projecting to the upper surface side of the nut so as to engage a screw groove; and
wherein the dropout prevention state of the nut is released by screwing a leading end of the bolt into the nut and thereby deforming the stopper part.

The stopper part of the nut-holding member may have a claw part projecting to the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bending the stopper part having the claw part.

The stopper part of the nut-holding member may be a claw part projecting to the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bending the claw part.

The stopper part of the nut-holding member may be constituted by a tilted part forming a side wall of the nut insertion part and overlapping the nut insertion part while tilting toward the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bringing the nut into contact with the tilted part and bending the side wall outward.

The stopper part of the nut-holding member may have a substantially L-shaped form comprising an arm part projecting to the upper surface side of the nut inserted in the nut insertion part and a projection part adapted to be inserted in a screw hole of the nut and engage a screw groove of the screw hole; and
the dropout prevention state of the nut may be released by screwing the bolt into the nut inserted in the nut insertion part, causing the leading end of the bolt to push the projection part engaging the screw groove of the nut to outside of the nut, and pushing the projection part out of the screw hole of the nut while bending the arm part.

The nut insertion part of the nut-holding member may be formed slightly larger than an outer form of the nut, while the nut inserted in the nut insertion part may be held loosely to such an extent as to be kept from rotating within the nut insertion part together with the screwing of the bolt.

The nut-holding member may be formed from a non-foaming synthetic resin or a low- or mid-foaming resin.

The bolt-joining method is a bolt-joining method for bolt-joining a plurality of bases having a bolt hole by using a nut-holding member;
the method comprising the steps of:
inserting a nut into the nut-holding member;
installing the nut-holding member in the base; and
bolt-joining the bases by screwing and fastening the bolt into the nut in the nut-holding member;
wherein the nut-holding member comprises a nut insertion part for inserting a nut therein such that the nut is kept from rotating together with screwing of a bolt, a stage part where an upper surface of the nut located on a side opposite from a bearing surface thereof is seated, and a stopper part for holding the nut in a dropout prevention state so that the nut inserted in the nut insertion part is kept from dropping out;
wherein the stopper part has such a shape as to project to the bearing surface side of the nut inserted in the nut insertion part serving as a surface to be installed on the base or a shape provided with a projection part projecting to the upper surface side of the nut so as to engage a screw groove;
wherein the stopper part attains the dropout prevention state where the nut inserted in the nut insertion part is kept from dropping out in the step of inserting the nut into the nut-holding member; and
wherein the dropout prevention state of the nut is released by screwing a leading end of the bolt into the nut and thereby deforming the stopper part in the bolt-joining step.

The stopper part of the nut-holding member may have a claw part projecting to the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bending the stopper part having the claw part in the bolt-joining step.

The stopper part of the nut-holding member may be a claw part projecting to the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bending the claw part in the bolt-joining step.

The stopper part of the nut-holding member may be constituted by a tilted part forming a side wall of the nut insertion part and overlapping the nut insertion part while tilting toward the bearing surface side of the nut inserted in the nut insertion part; and
the dropout prevention state of the nut may be released by screwing the bolt into the nut inserted in the nut insertion part, rotating the bolt so as to move the nut toward a head of the bolt, and thereby bringing the nut into contact with the tilted part and bending the side wall outward in the bolt-joining step.

The stopper part of the nut-holding member may have a substantially L-shaped form comprising an arm part projecting to the upper surface side of the nut inserted in the nut insertion part and a projection part adapted to be inserted in a screw hole of the nut and engage a screw groove of the screw hole; and
the dropout prevention state of the nut may be released by screwing the bolt into the nut inserted in the nut insertion part, causing the leading end of the bolt to push the projection part engaging the screw groove of the nut to outside of the nut, and pushing the projection part out of the screw hole of the nut while bending the arm part in the bolt-joining step.

The nut insertion part of the nut-holding member may be formed slightly larger than an outer form of the nut, while the nut inserted in the nut insertion part may be held loosely to such an extent as to be kept from rotating within the nut insertion part together with the screwing of the bolt.

The nut-holding member may be formed from a non-foaming synthetic resin or a low- or mid-foaming resin.

### Advantageous Effects of Invention

The above-mentioned nut-holding member and bolt-joining method yield the following effects. (1) The stopper part provided in the nut insertion part is configured to be deformable such as to release the dropout prevention state of the nut when the leading end of the bolt is screwed into the nut of the nut-holding member and the resulting rotation of the bolt moves the nut toward the head of the bolt or when the leading end of the bolt is screwed into the screw hole of the nut.

Therefore, while the nut inserted in the nut insertion part is securely prevented from dropping out when installing the nut-holding member, the turning force by which the nut moves to the head position of the bolt as the bolt rotates is utilized when fastening the bolt and nut to each other, so as to spread or bend the stopper part projecting to the bearing surface side of the nut, which pushes away the stopper part from between the bolt and nut, thereby effectively releasing the dropout prevention state of the nut. Alternatively, when the leading end of the bolt is screwed into the screw hole of the nut, the stopper part arranged in the screw hole deforms as the bolt advances, so as to be pushed out of the nut, whereby the dropout prevention state of the nut can be released. Continuing the screwing as it is can bring the nut into close contact with the base, so as to perform firm bolt-joining eternally in a stable manner.

(2) Each of the nut-holding member and bolt-joining method comprises a nut insertion part for inserting a nut therein such that the nut is kept from rotating together with screwing of the bolt and a stopper part for holding the nut in a dropout prevention state so that the nut inserted in the nut insertion part is kept from dropping out, while the nut insertion part in particular is formed slightly larger than the outer form of the nut, so that the nut inserted in the nut insertion part is held loosely to such an extent as to be kept from rotating within the nut insertion part together with the screwing of the bolt. Thus providing the nut with some play allows the nut to rotationally move to the starting end of the bolt, whereby the alignment of the joining bolt inserted at the time of bolt-joining with the nut and the bolt-fastening operation can be performed freely by manipulating the bolt alone. Therefore, the positioning (searching and aligning of the starting end of the bolt) at the beginning of the bolt-joining can also be carried out rapidly, whereby the bolt-joining operation with favorable operating efficiency can be performed.

This can further avoid troubles such as screwing in tilted states, whereby a stable fixing property can be expected.

### BRIEF DESCRIPTION OF DRAWINGS

FIG. 1 is a perspective view illustrating an example of the nut-holding member in accordance with an embodiment;

FIGS. 2A to 2C are sectional views illustrating stepwise how a stopper part moves when a bolt is screwed into a nut inserted in a nut insertion part of the nut-holding member;

FIG. 3 is a plan view illustrating, in a partial cutaway, a road safety fence employing a bolt-joining structure;

FIG. 4 is a front view of the road safety fence illustrated in FIG. 3;

FIG. 5 is a side view of the road safety fence illustrated in FIG. 3;

FIG. 6 is a reference diagram illustrating an example of how to insert the nut-holding member into a hollow of an inner sleeve and join beam pipes thereto;

FIG. 7 is a perspective view illustrating an example of the nut-holding member in accordance with Example 3;

FIGS. 8A to 8C are sectional views illustrating stepwise how the stopper part moves when the bolt is screwed into the nut inserted in the nut insertion part of the nut-holding member of FIG. 7;

FIG. 9 is a perspective view illustrating an example of the nut-holding member in accordance with Example 4;

FIGS. 10A to 10C are sectional views illustrating stepwise how the stopper part moves when the bolt is screwed into the nut inserted in the nut insertion part of the nut-holding member of FIG. 9;

FIG. 11 is a perspective view illustrating an example of the nut-holding member in accordance with Example 5 as seen with its bottom surface on the upper side; and

FIGS. 12A to 12C are sectional views illustrating stepwise how the stopper part moves when the bolt is screwed into the nut inserted in the nut insertion part of the nut-holding member of FIG. 11.

### DESCRIPTION OF EMBODIMENTS

The nut-holding member in accordance with this embodiment is a nut-holding member 5 for use when bolt-joining a base 3 (4) having a bolt hole 3a (4a).

The nut-holding member 5 is constituted by a nut insertion part 51 for inserting a nut 6 therein such that the latter is kept from rotating together with screwing of a bolt, a stage part 52 where the upper surface (surface on the side not coming into contact with the base 3 (4)) of the nut 6 is seated, and a stopper part 53 for holding the nut in a dropout prevention state so that the nut 6 inserted in the nut insertion part 51 is kept from dropping out.

The nut insertion part 51 of the nut-holding member 5 is formed slightly larger than the outer form of the nut 6, while the nut 6 inserted in the nut insertion part 51 is held loosely to such an extent as to be kept from rotating within the nut insertion part 51 together with the screwing of the bolt.

The stopper part 53 has such a shape as to be elastically deformable to release the dropout prevention state when the leading end of a bolt 9 (10, 11) is screwed into the nut 6 of the nut-holding member 5 and the nut 6 is moved toward the head of the bolt 9 (10, 11) by the rotation of the bolt.

### Example 1

The following explanation will be based on an example illustrating one embodiment.

While the nut-holding member 5 is used when bolt-joining with a plurality of bases having a bolt hole, this example employs beam pipes 4, an inner sleeve 3, and a bracket 2 of a road safety fence as examples of bases having various forms to be bolt-joined, and the nut-holding member 5 for use in each bolt joint will mainly be explained.

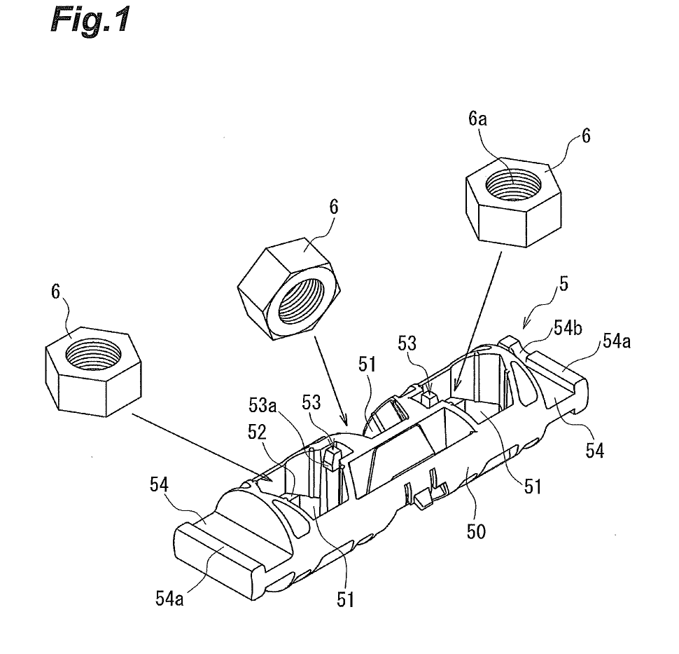

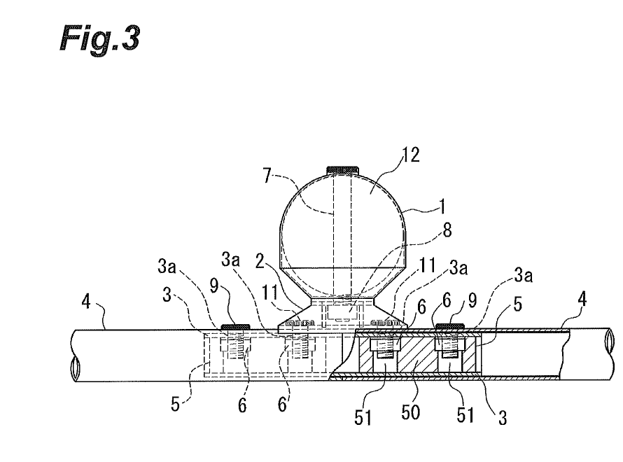

FIGS. 3 to 5 illustrate an example of a road safety fence in which a bolt joint is constructed by attaching the bracket 2 to a pole 1 and mounting the beam pipe 4 to the bracket 2 through the inner sleeve 3 while utilizing the nut 6 held by the nut-holding member 5 illustrated in FIG. 1 inserted in the hollow of the inner sleeve 3.

The nut-holding member 5 for use in the road safety fence is favorably employed for joining with bolts 9, 10, 11 which attach the bracket 2 to the intermediate post 1 (hereinafter simply referred to as post 1) located in the middle of the length of the beam pipe 4 and mount the intermediate part of the beam pipe 4 to the bracket 2.

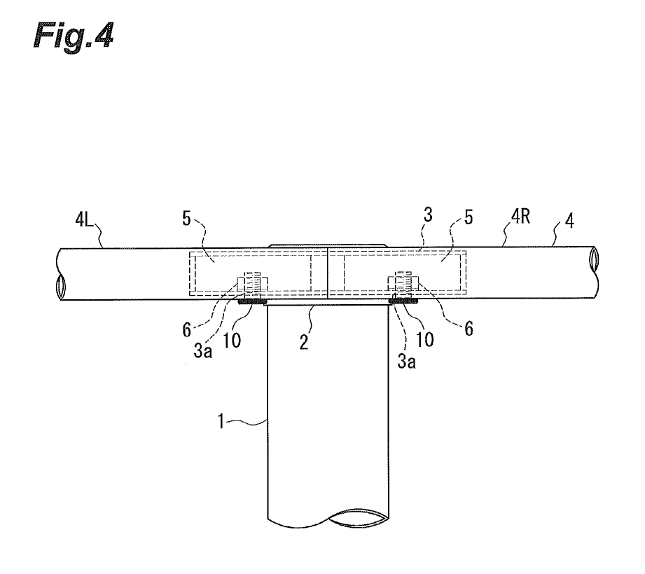

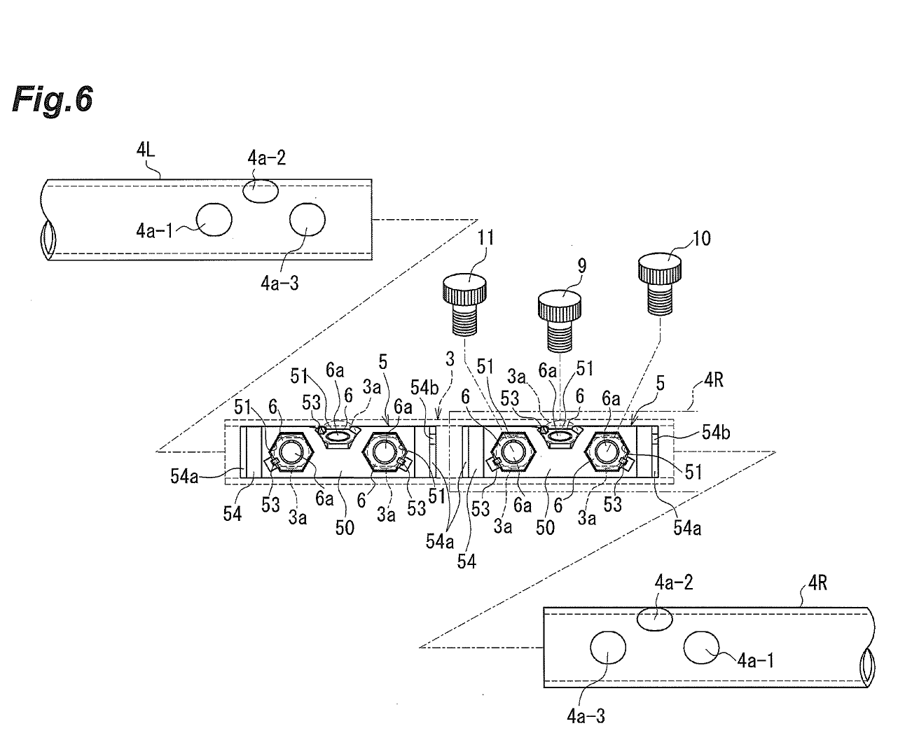

As illustrated in FIG. 1, the outer peripheral surface of the nut-holding member 5 has such a shape as to be inserted into the hollow of the inner sleeve 3 (see FIGS. 4 and 6) and come into contact with the inner surface of the inner sleeve 3 so as to be inhibited from moving in directions orthogonal to the tube axis of the inner sleeve 3. This is such a shape that the nut-holding member 5 has a diameter made slightly smaller than that of the hollow of the inner sleeve 3 so as to be accommodated tightly in the latter and restrained from moving in directions orthogonal to the tube axis.

In Example 1, by shaping the cross section of the nut-holding member 5 into such a form (e.g., a substantially circular form similar to but slightly smaller than the cross sectional form of the inner sleeve 3) as to inhibit it from moving in directions orthogonal to the tube axis of the inner sleeve 3 as mentioned above, the nut-holding member 5 is positioned with respect to the inner sleeve 3, which is a base, at a position where the nut 6 and a bolt hole of the base align with each other. However, the positioning of the nut-holding member 5 with respect to the base in the present application is not limited to the above. The nut-holding member using the technical idea of the present application, including all the examples thereof, may use any securing method with respect to the base without being restricted at all. For example, the nut-holding member may be positioned with respect to the base by suction through a suction cup as in the above-mentioned Patent Literature 1. Riveting or self-tapping screws may be used as in Patent Literature 2, inserting into a depression part may be employed, end parts or raised parts of the base may be nipped, and any of methods such as temporary bonding with adhesives and temporary welding may be employed as long as the nut-holding member can be positioned with respect to the base. This installation method is similarly used in other examples explained in the following and thus will not be mentioned therein.

The exterior form of the nut-holding member is employed as various shapes corresponding to these various manners of positioning.

On the outer peripheral surface of the nut-holding member 5, nut insertion parts 51 for inserting the respective nuts 6 therein so as to keep the latter from rotating together with screwing of their corresponding bolts are provided in such an arrangement as to coincide with bolt holes 3a of the inner sleeve 3. Each nut insertion part 51 has the stopper part 53 for holding the inserted nut 6 in a dropout prevention state. In short, the nut-holding member 5 is mainly constituted by a shaped member 50 having such a length and outer diameter as to be able to hold the nuts 6 in so-called three-dimensional directions in such an arrangement in its tube axis and peripheral directions as to correspond to the number and arrangement of bolt holes 3a provided beforehand in the inner sleeve 3.

The shaped member 50 of this example can be formed from thermosetting or thermoplastic synthetic resins such as phenol, epoxy, melamine, unsaturated polyester, and polyurethane resins, for example, so as to be suitable for mass production, inexpensive to manufacture, and easy to handle. It is also preferably formed from low-, mid-, or high-foaming polystyrene or polypropylene resins and the like. It can also be manufactured from non-foaming synthetic resins, wood, or metals.

Specifically, the nut insertion part 51 of the shaped member 50, which is a hole for inserting a nut at an insertion position for the nut 6, is provided such as to penetrate through the shaped member 50 in a direction orthogonal to the center axis of an extension of the inner sleeve 3. The nut insertion part 51 is shaped into such a form and size as to secure the inserted nut 6 to such an extent as to keep it from rotating together with the bolt-joining operation.

The nut-holding member 51 is formed such as to define a through-hole in order to thin the shaped member 50, so as to reduce the amount of its materials for use and make it lighter, thereby cutting down the manufacturing cost. The nut-holding member 51 has the following structure as a hexagonal form with such a size as to be able to insert the depicted regular hexagonal nut 6 easily therein with such a margin that the nut 6 can be somewhat shaken by the leading end of the bolt for joining therewith.

At a depth corresponding to the height of the nut 6 from the outer peripheral surface of the shaped member 50, the nut insertion part 51 is formed with the stage part 52 where the upper surface (surface on the side not coming into contact with the inner wall of the inner sleeve 3) of the nut 6 is seated. The nut 6 inserted in the nut insertion part 51 has such a structure as to seat its upper surface on the stage part 52 and be stabilized into such a state as to be kept from rotating together with screwing of the bolt. Therefore, the through-hole form and size of the nut insertion part 51 in its part deeper than the stage part 52 is configured such that the leading end part of the bolt screwed into the nut 6 is kept from coming into contact with the nut insertion part 51, while thinning the shaped member 50 so as to achieve the object of reducing the amount of its materials for use and making it lighter as necessary. On the other hand, the bearing surface (surface on the side coming into contact with the inner wall of the inner sleeve 3) of the nut 6 stabilized at the stage part 52 is inserted in the nut insertion part 51 so as to sink a little deeper than the outer peripheral surface of the shaped member 50 and be exposed near the outer periphery to such an extent as to become no obstacle when inserting the shaped member 50 into the hollow of the inner sleeve 3.

For preventing the nut 6 inserted in the nut insertion part 51 as mentioned above from unnecessarily moving up and disadvantageously dropping out, the nut-holding member 5 is provided with the stopper part 53 for pressing the bearing surface of the nut 6 as the stopper part 53 having a claw part 53a at the upper end part.

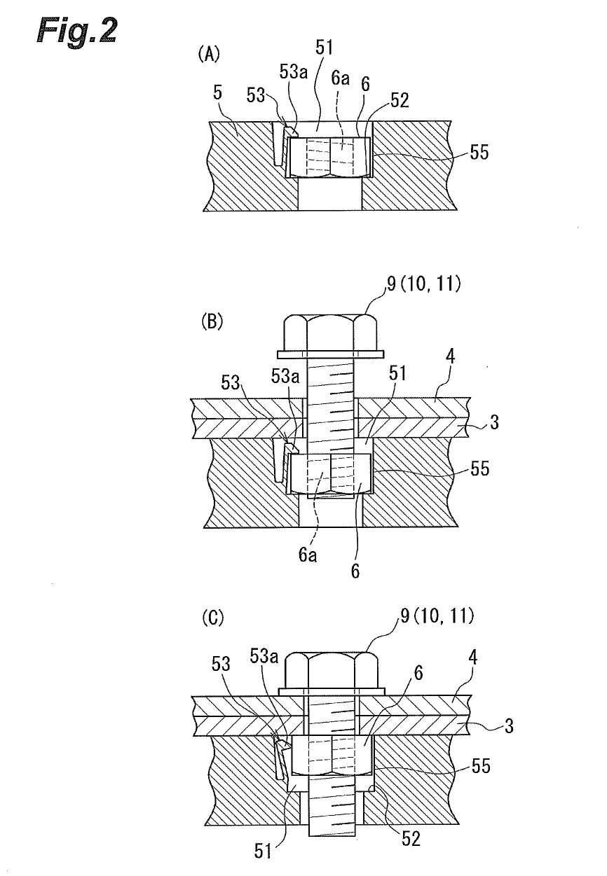

In FIGS. 2 and 6, it is provided at the center part of one side of the hexagon in an entrance portion of the nut insertion part 51 by such a structure as to shape a constituent material of the molded member 50 into a form which is elastically deformable and can release the dropout prevention state.

That is, when the nut 6 is inserted into the nut insertion part 52 by pushing away the stopper part 53 having the elastically deformable form located in the entrance portion of the nut insertion part 51 as illustrated in FIG. 2A, the stopper part 53 (claw part 53a) immediately acts to stop it, thereby preventing the nut 6 from unnecessarily moving up and dropping out.

When the bolt 9 (including 10, 11) (see FIGS. 3 to 5) is screwed into a screw hole 6a of the nut 6 inserted in the nut insertion part 51 as illustrated in FIG. 2B, however, a turning force by which the nut 6 moves to the head position of the bolt 9 occurs as the bolt 9 rotates, since the nut 6 is held in such a state as to be kept from rotating together with screwing of the bolt. This turning force causes the stopper part 53 to spread or bend outward (FIG. 2C), so as to be pushed away from between the bolt and nut, whereby the dropout prevention state of the nut 6 is released. Continuing the screwing as it is can securely bring the bearing surface of the nut 6 into close contact with the base, so as to perform firm bolt-joining. Here, number 55 indicates a rotation prevention wall for preventing the corotation of the nut mentioned above.

Both end parts of the nut-holding member 5 are provided with grip parts 54 for the convenience of inserting/drawing operations into/from the inner sleeve 3, while both of the upper and lower faces of leading end parts of the grip parts 54 are preferably formed with grip part ends 54a which make them easier to grip with fingers or harder to slip. This aims to make it easier to discern the insertion direction of the nut-holding member 5 by eyes or the touch and feel upon grasping with a hand, while the grip part 54 may be formed with a depression 54b as appropriate (see FIG. 6).

A bolt joint for connecting the beam pipes 4 to each other and mounting them to the pole 1 by using thus constructed nut-holding member 5 will now be explained with reference to FIGS. 3 to 6.

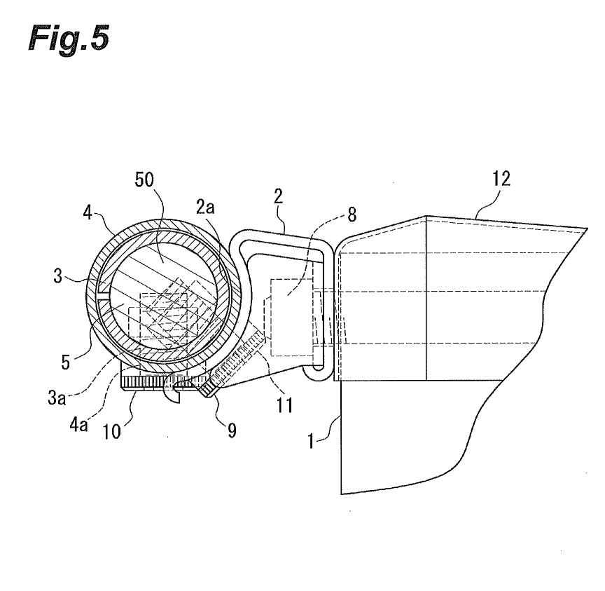

First, prior to the bolt-joining operations mentioned above, the bracket 2 is attached to the upper end of the pole 1 with a bolt 7 horizontally (diametrically) penetrating through the upper end part thereof toward the road side and a nut 8. As illustrated in FIGS. 3 and 5, the other end of the bolt 7 and the nut 8 fastened thereto are covered in their upper surface parts with a pipe receiving part 2a projecting to the road side from the securing part of the bracket 2 secured to the pole with the bolt 7 and the nut 8 by way of the part thereabove.

For mounting the beam pipes 4 through the inner sleeve 3 to the bracket 2 attached to the pole 1 as mentioned above, two nut-holding members 5 formed with the nut insertion parts 51 coinciding with the arrangement and number of bolt holes 3a in the inner sleeve 3 are initially inserted as left and right ones into the hollow of the inner sleeve 3 from its openings at the left and right ends and positioned therein by utilizing the grip parts 54 as illustrated in FIGS. 4 and 6.

Subsequently, for example, the inner sleeve 3 is inserted into the hollow of the right beam pipe 4R to its middle position, i.e., until the left part of the inner sleeve 3 projects out of the leading end of the beam pipe 4R, so that bolt holes 4a-1 to 4a-3 provided beforehand in an end part of the beam pipe 4R align with their corresponding (three) bolt holes 3a in the inner sleeve 3.

Thereafter, the bolts 9, 10 are inserted into the innermost bolt hole 4a-1 and the second innermost bolt hole 4a-2 among the three bolt holes 4a of the beam pipe 4R and screwed and fastened into their corresponding nuts 6 in the nut-holding member 5. Here, as mentioned above, the stopper part 53 (claw part 53a) provided in each nut insertion part 51 of the nut-holding member 5 comes into contact with the nut 6 moving toward the head of the bolt 9, 10 as the bolt rotates, so as to be pushed out (FIG. 2C), which effectively releases the dropout prevention state of the nut 6, thereby bringing the bearing surface of the nut 6 into close contact with the inner wall of the inner sleeve 3, thus performing bolt-joining with high accuracy in fixing.

A structure for mounting the beam pipe 4R in the above-mentioned state to the bracket 2 attached to the pole 1 will now be explained.

The front face of the bracket 2 attached to the pole 1 is provided with the pipe receiving part 2a curved into a concave cross section with the same radius of curvature as that of the outer form of the beam pipe 4R (see FIG. 5). The beam pipe 4R projecting out the left half of the inner sleeve 3 as mentioned above is mounted to the pipe receiving part 2a. Then, the bolt hole (not depicted) provided beforehand in the pipe receiving part 2a on the front face of the bracket 2 and the bolt hole 4a-3 closest to the outer end in the beam pipe 4R are aligned with each other, and the bolt 11 is inserted into this bolt hole from the back side of the pipe receiving part 2a and screwed into its corresponding nut 6 in the nut-holding member 5, so as to rotate to release the dropout prevention state of the stopper part 53 (claw part 53a) and be fastened as mentioned above, whereby the beam pipe 4R, inner sleeve 3, and bracket 2 are firmly bolt-joined as a three-in-one unit.

Number 12 in FIG. 1 indicates a cap which is put on the upper end of the pole 1 and secured with the bolt 7.

After the beam pipe 4R projecting out the left half of the inner sleeve 3 is mounted to the bracket 2 as mentioned above, the left beam pipe 4L is prepared, so as to fit its hollow onto the projected left half of the inner sleeve 3 and abut against the right beam pipe 4R, which has already been bolt-joined, at the longitudinal center part of the inner sleeve 3, and bolt holes 4a-1, 4a-2 provided beforehand in an end part of the beam pipe 4L are aligned with their corresponding bolt holes 3a on the left side of the inner sleeve 3, so that they are bolt-joined with the bolts 9, 10 in the manner mentioned above.

Thereafter, the bolt hole 4a-3 of the beam pipe 4L and the bolt hole of the bracket 2 are bolt-joined with the bolt 11 in the same manner as mentioned above, whereby the beam pipes 4R, 4L are completely connected to each other and bolt-joined to the pole 1.

Hence, the nut-holding member 5 can freely perform the alignment between the joint bolt inserted at the time of bolt-joining and the nut and the bolt-fastening operation by manipulating the bolt alone, thereby making the bolt-joining easier and more accurate at locations harder to be visually inspected by operators. The stopper part 53 (claw part 53a) of the nut-holding member 5 securely prevents the nut 6 inserted in the nut insertion part 51 from dropping out when the nut-holding member 5 is installed in the inner sleeve 3 but, when fastening the bolt and nut, utilizes the turning force by which the nut 6 moves to the head position of the bolt 9 as the bolt 9 (10, 11) rotates, so as to spread out or bend, thereby being pushed out and effectively releasing the dropout prevention state of the nut 6, which enables firm bolt-fastening with high adhesion.

### Example 2

The present invention is not limited to Example 1, which explains the nut-holding member 5 for use in bolt joints of beam pipes for road safety fences, as a matter of course.

The structures such as the nut insertion part 51 and stopper part 53 mentioned above for better bolt-joining can also be employed when bolt-joining bases having bolt holes such as liner plates and joints, for example, by changing the design of their overall forms as appropriate. That is, the structure by which the stopper part 53 prevents the nut from dropping out when installing the nut-holding member 5 in the base but effectively releases the dropout prevention state of the nut at the time of bolt-joining.

### Example 3

The structure of the stopper part 53 in the nut-holding member 5 is not limited to that explained in Example 1.

That is, it will be sufficient if the structure can prevent the nut 6 from dropping out when holding the nut 6 in the nut insertion part 51 of the nut-holding member 5 and release the dropout prevention state of the nut by utilizing a turning force of the nut 6 caused by a rotation of a bolt at the time of bolt-joining.

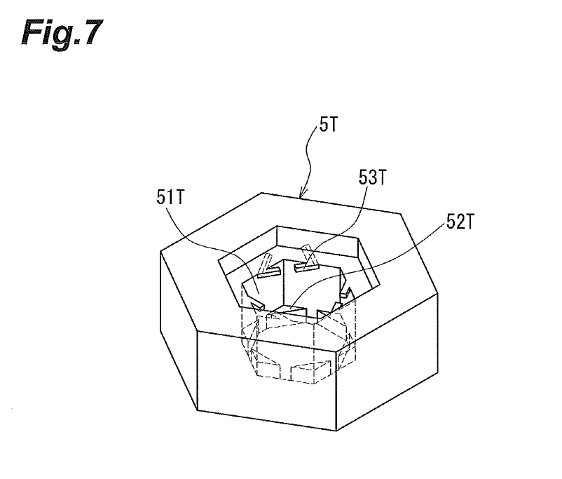

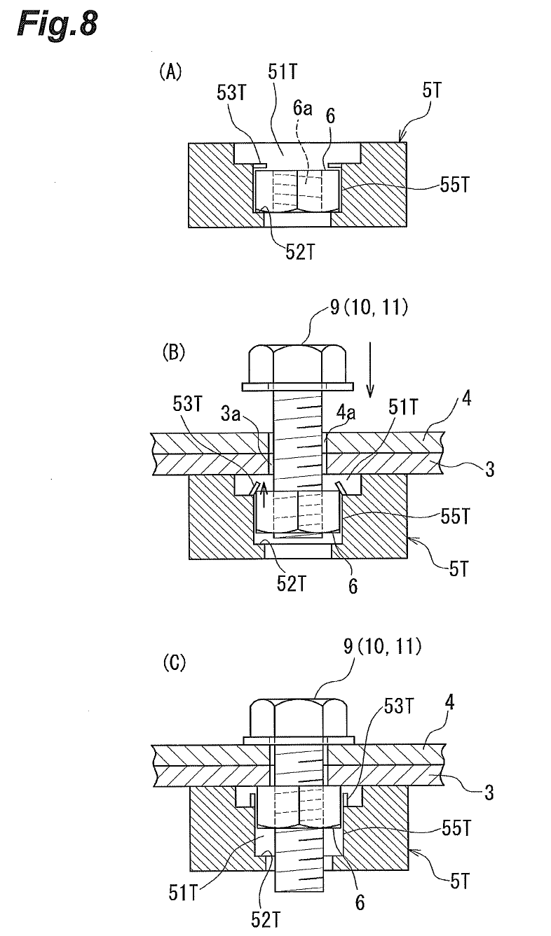

FIGS. 7 and 8A to 8C illustrate a nut-holding member 5T in a simple form with a single nut insertion part 51. For the record, it is additionally noted that the nut-holding member 5 illustrated in FIG. 1 can be carried out in the same manner even when a plurality of nut insertion parts 51 therein are replaced with those of this example, as a matter of course.

The depicted nut-holding member 5T has basically the same technical idea as that of the nut-holding member 5 illustrated in FIG. 1.

The nut insertion part 51 for holding the nut 6 has a hexagonal form with such a play as to secure the nut 6 to such an extent that the nut 6 is prevented from rotating together with screwing of a bolt but can shake somewhat at the leading end of the bolt, while its bottom part is provided with a stage part 52T where the upper surface of the nut 6 is seated and defines a through-hole in order for the bolt to pass therethrough. The nut insertion part 51 has such a depth that the upper surface of the nut 6 can sink a little deeper than the outer peripheral surface of the nut-holding member 5T, while its upper part is formed much wider than the nut 6 so that the bolt can easily be inserted therein.

Further provided are stopper parts 53T for preventing the nut 6 from unnecessarily dropping out when the nut 6 is inserted in the nut insertion part 51T. The stopper parts 53T are provided as claw parts 53T projecting horizontally inward within the nut insertion part 51T while overlapping the bearing surface of the nut 6 inserted in the nut insertion part 51T. The depicted claw parts 53T, which are made of an elastically deformable resin, are arranged so as to oppose each other with a fixed space therebetween at three corners. Meanwhile, number 55T indicates a rotation prevention wall for preventing the corotation of the nut.

Therefore, when the nut 6 is inserted into the nut insertion part 51 T from thereabove by pushing down the elastically deformable claw parts 53T located at three corners of the nut insertion part 51T, the stopper parts 53T immediately return to their original horizontal positions and project to the bearing surface of the nut 6 as illustrated in FIG. 8A, so as to prevent the nut 6 from dropping out.

Thus constructed nut-holding member 5T is installed on the inner wall of a base (hereinafter simply referred to as base 3 (4), including the inner sleeve 3 and beam pipe 4) at a position where its nut insertion part 51T and a bolt hole (3a, 4a) of the base 3 (4) align with each other, and the bolt 9 (10, 11) is passed through the bolt hole (3a, 4a) of the base 3 (4) and screwed into the screw hole 6a of the nut 6 inserted in the nut insertion part 51T, whereby the claw parts 53T bend upward when the nut 6 moves toward the head of the bolt 9 as the bolt rotates, so as to release the dropout prevention state of the nut, and continuously rotating the bolt as it is can bring the bearing surface of the nut 6 into close contact with the inner wall of the base 3 (4), so as to perform firm bolt-joining.

### Example 4

The structure of the stopper part 53 in the nut-holding member 5 is not limited to Examples 1 and 3.

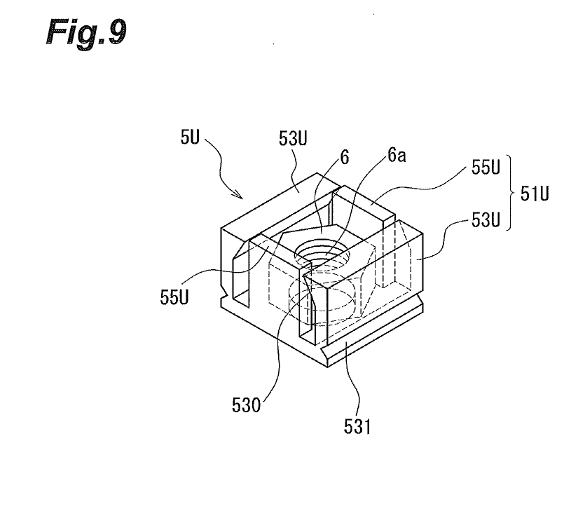

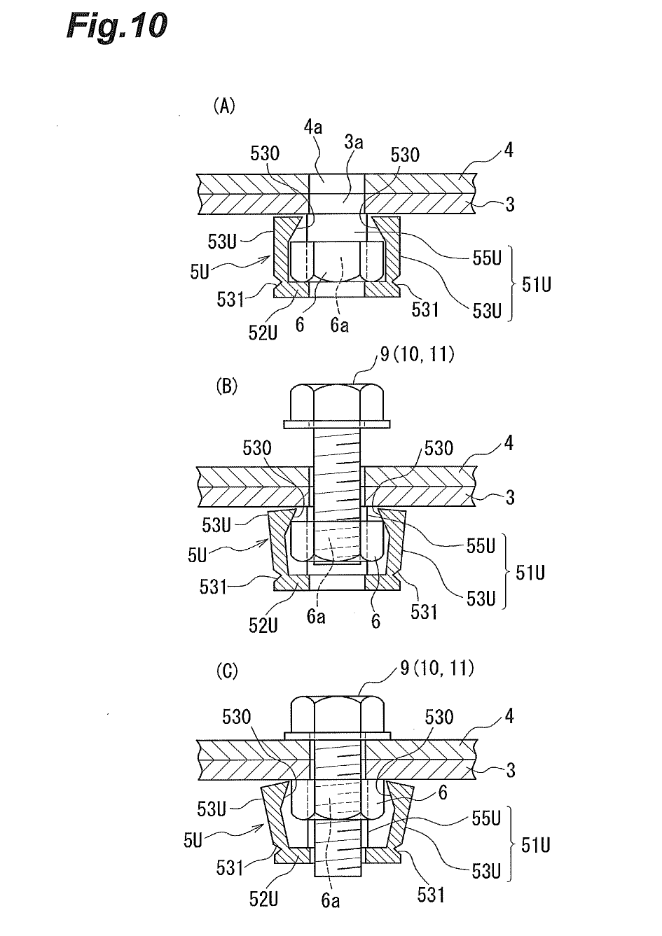

FIGS. 9 and 10A to 10C illustrate the nut-holding member 5U of Example 4.

While this nut-holding member 5U is also represented in a simple form with a single nut insertion part 51, the nut-holding member 5 illustrated in FIG. 1 can be carried out in the same manner even when a plurality of nut insertion parts 51 therein are replaced with those of this example, as a matter of course.

The nut-holding member 5U has a rectangular bottom part, while its center part defines a through-hole in order for a bolt to pass therethrough. The nut insertion part 51U is constituted by rotation prevention walls 55U rising from two sides opposing each other in a rectangular bottom part and stopper parts 53U (also referred to as stopper walls) rising from the other two sides opposing each other. That is, the stopper parts 53U constitute two side walls of the nut insertion part 51U. As a matter of course, the nut insertion part 51U may also employ a structure in which the stopper parts 53U are disposed on all of the four sides or a structure in which the rotation prevention walls 55U are provided as three side walls while the stopper part 53U rises from the remaining one side.

The rotation prevention walls 55U are formed slightly higher than the stopper walls 53U, so as to constrain two sides opposing each other in the hexagonal nut 6, thereby preventing the nut 6 from rotating together with screwing of the bolt. The stopper walls 53U, 53U forming the two side walls have a gap therebetween to such an extent as to allow the nut 56 to shake at the leading end of the bolt, while each being constituted by a tilted part 530 having its upper portion tilting inward to such an extent as to overlap the bearing surface (surface on the side coming into contact with the base 3 (4)) of the nut 6 and a V-shaped cutout 531 yielding a thinner cross section disposed on the lower side of the outer wall of the stopper wall 53U. The cutout 531 may also be disposed on the lower side of the inner wall of the stopper wall 53U. A member constituting the nut insertion part 51U is formed from an elastically deformable material. Therefore, the nut 6 to be inserted in the nut insertion part 51U can be set by spreading out the elastically deformable stopper walls 53U, 53U. The nut 6 inserted in the nut insertion part 51U is set so as to be seated on a stage part 52U.

As illustrated in FIG. 10A, the nut-holding member 5U equipped with the nut 6 is installed on the inner wall of the base 3 (4) by any of the various positioning methods mentioned above such that the nut insertion part 51U and the bolt hole (3a, 4a) of the base 3 (4) align with each other while the inner wall of the base 3 (4) and the top face of the rotation prevention wall 55U, which is taller in height and constitutes the nut insertion part 51U, are in contact with each other. At this time, a gap naturally occurs between the top part of the stopper wall 53U, which is shorter in height, and the inner wall of the base 3 (4). When the base does not have a closed cross section, only the top face of the rotation prevention wall 55U is connected to the inner wall of the base 3 (4) by welding or the like.

When the bolt 9 (including 10, 11) is passed through the bolt hole (3a, 4a) of the base 3 (4) and screwed into the screw hole 6a of the nut 6 inserted in the nut insertion part 51U as illustrated in FIG. 10B in the state mentioned above, as the rotation of the bolt causes the nut 6 kept from rotating together with the bolt to move toward the head of the bolt 9, the nut 6 comes into contact with the tilted part 530 of the stopper wall 53U constituting the nut insertion part 51U, so as to bend the stopper wall 53U outward from its cutout 531, thereby releasing the dropout prevention state of the nut 6, and continuing the screwing as it is can securely bring the bearing surface of the nut 6 into close contact with the inner wall of the base 3 (4), so as to perform firm bolt-joining. Here, the stopper wall 53U is formed shorter in height and thus has no possibility of coming into contact with the base 3 (4) when bending outward.

### Example 5

The structure of the stopper part 53 in the nut-holding member 5 is not limited to Examples 1, 3, and 4.

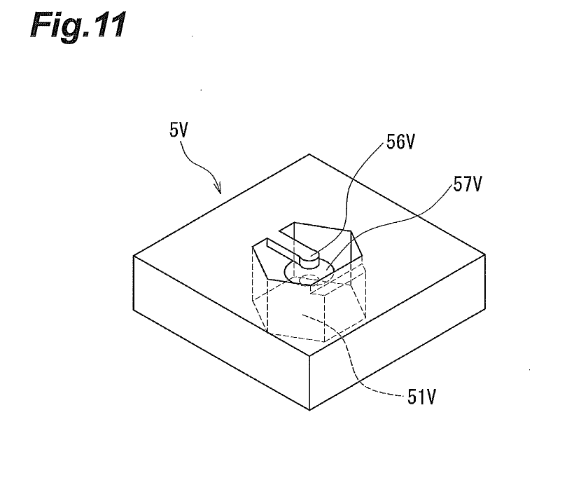

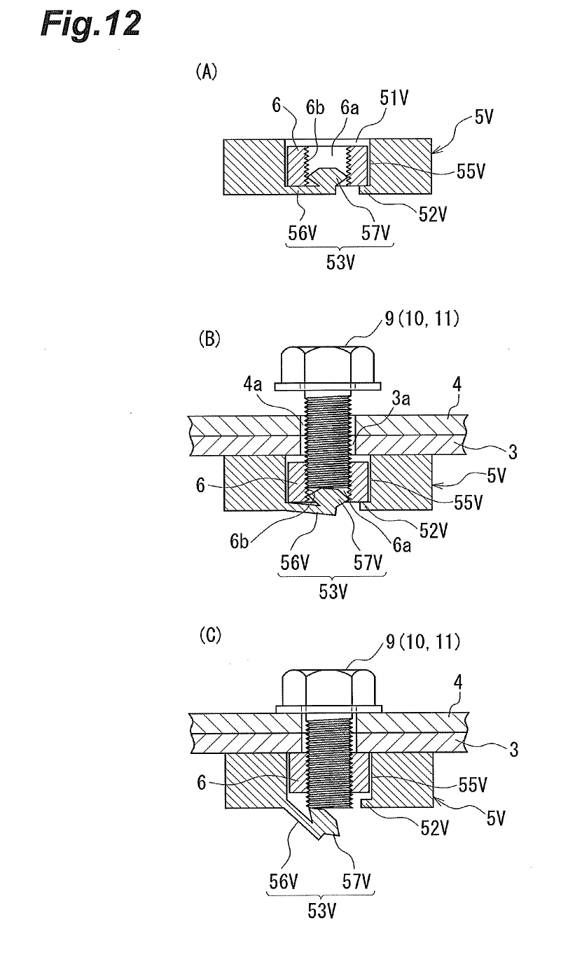

FIGS. 11 and 12A to 12C illustrate the nut-holding member 5V of Example 5. While this nut-holding member 5V is also represented in a simple form with a single nut insertion part 51, the nut-holding member 5 illustrated in FIG. 1 can be carried out in the same manner even when a plurality of nut insertion parts 51 therein are replaced with those of this example, as a matter of course.

This nut-holding member 5V is also formed with a hexagonal nut insertion part 51V having some play while keeping the hexagonal nut 6 from rotating together with screwing of the bolt. The bottom part of this hexagonal nut insertion part 51V also defines a through-hole.

The nut insertion part 51V is also provided with a stopper part 53V which prevents the nut 6 from dropping out and, at the time of bolt-joining, releases the dropout prevention state of the nut 6. Number 55V also indicates a rotation prevention wall for preventing the nut 6 from rotating together with screwing of the bolt.

As illustrated in FIG. 12A, the stopper part 53V has an arm part 56V extending horizontally from the bottom part of the nut insertion part 51V and a projection part 57V adapted to be inserted in the screw hole 6a of the nut 6 and engage the screw groove 6b of the screw hole 6a of the nut 6. That is, the stopper part 53V has a substantially L-shaped form comprising the arm part 56V and the projection part 57V. While the horizontal part of the arm part 56V may also serve as a stage part 52V for the nut 6 to seat, the stage part 52V may be provided separately as illustrated in FIG. 12A. The projection part 57V is provided with such a size and form as to engage the screw groove 6b of the nut 6.

Therefore, the nut 6 to be inserted in the nut insertion part 51V is put into the nut insertion part 51V from thereabove and pushed such that the projection part 57V of the stopper part 53V is accommodated in the screw hole 6a of the nut 6, whereby the projection part 57V engages the screw groove 6b and prevents the nut 6 from dropping out.

As illustrated in FIG. 12B, when the nut-holding member 5V equipped with the nut 6 is installed at a position where the nut insertion part 51V and the bolt hole (3a, 4a) of the base 3 (4) align with each other, and the bolt 9 (10, 11) is passed through the bolt hole (3a, 4a) of the base 3 (4) and screwed into the nut 6 inserted in the nut insertion part 51y, as the bolt 9 (10, 11) advances, the projection part 57V constituting the stopper part 53V inserted in the screw hole 6a of the nut 6 is pushed down, so as to bend the arm part 56V, and further rotating the bolt 9 (10, 11) pushes the projection part 57V out of the nut 6. This releases the dropout prevention state of the nut 6, and continuing the screwing as it is can securely bring the bearing surface of the nut 6 into close contact with the inner wall of the base, so as to perform firm bolt-joining.

While the foregoing explanation is based on examples illustrating one embodiment, the present invention is not limited to the structures of the above-mentioned examples. For the record, it is noted that the present invention encompasses ranges of design changes and variations of applications performed by one skilled in the art as necessary within the scope not deviating from its object and gist. For example, while the depicted examples explain the nut-holding members holding hexagonal nuts, the present invention can also be carried out with quadrangular nuts based on the same technical idea.

### INDUSTRIAL APPLICABILITY

The present invention can be utilized for the nut-holding member and bolt-joining method for use when bolt-joining bases having a bolt hole.

### REFERENCE SIGNS LIST

1 . . . pole; 2 . . . bracket; 3 . . . inner sleeve; 3a . . . bolt hole; 4 . . . beam pipe; 5, 5T, 5U, 5V . . . nut-holding member; 6 . . . nut; 9, 10, 11 . . . bolt; 51 . . . nut insertion part; 52 . . . stage part; 53 . . . stopper part (stopper wall); 53a . . . claw part; 54 . . . grip part; 55 . . . rotation prevention. wall; 56V . . . arm part; 57V . . . projection part

1. A nut-holding member for use when bolt-joining a plurality of bases having a bolt hole;
the nut-holding member comprising a nut insertion part for inserting a nut therein such that the nut is kept from rotating together with screwing of a bolt, a stage part where an upper surface of the nut located on a side opposite from a bearing surface thereof is seated, and a stopper part for holding the nut in a dropout prevention state so that the nut inserted in the nut insertion part is kept from dropping out;
wherein the stopper part has such a shape as to project to the bearing surface side of the nut inserted in the nut insertion part serving as a surface to be installed on the base or a shape provided with a projection part projecting to the upper surface side of the nut so as to engage a screw groove; and
wherein the dropout prevention state of the nut is released by screwing a leading end of the bolt into the nut and thereby deforming the stopper part.

2. A nut-holding member according to claim 1, wherein the stopper part of the nut-holding member has a claw part projecting to the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bending the stopper part having the claw part.

3. A nut-holding member according to claim 1, wherein the stopper part of the nut-holding member is a claw part projecting to the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bending the claw part.

4. A nut-holding member according to claim 1, wherein the stopper part of the nut-holding member is constituted by a tilted part forming a side wall of the nut insertion part and overlapping the nut insertion part while tilting toward the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bringing the nut into contact with the tilted part and bending the side wall outward.

5. A nut-holding member according to claim 1, wherein the stopper part of the nut-holding member has a substantially L-shaped form comprising an arm part projecting to the upper surface side of the nut inserted in the nut insertion part and a projection part adapted to be inserted in a screw hole of the nut and engage a screw groove of the screw hole; and
wherein the dropout prevention state of the nut is released by screwing the bolt into the nut inserted in the nut insertion part, causing the leading end of the bolt to push the projection part engaging the screw groove of the nut to outside of the nut, and pushing the projection part out of the screw hole of the nut while bending the aim part.

6. A nut-holding member according to claim 1, wherein the nut insertion part of the nut-holding member is formed slightly larger than an outer form of the nut, while the nut inserted in the nut insertion part is held loosely to such an extent as to be kept from rotating within the nut insertion part together with the screwing of the bolt.

7. A nut-holding member according to claim 1, wherein the nut-holding member is formed from a non-foaming synthetic resin or a low- or mid-foaming resin.

8. A bolt-joining method for bolt-joining a plurality of bases having a bolt hole by using a nut-holding member;
the method comprising the steps of:
inserting a nut into the nut-holding member;
installing the nut-holding member in the base; and
bolt-joining the bases by screwing and fastening the bolt into the nut in the nut-holding member;
wherein the nut-holding member comprises a nut insertion part for inserting a nut therein such that the nut is kept from rotating together with screwing of a bolt, a stage part where an upper surface of the nut located on a side opposite from a bearing surface thereof is seated, and a stopper part for holding the nut in a dropout prevention state so that the nut inserted in the nut insertion part is kept from dropping out;
wherein the stopper part has such a shape as to project to the bearing surface side of the nut inserted in the nut insertion part serving as a surface to be installed on the base or a shape provided with a projection part projecting to the upper surface side of the nut so as to engage a screw groove;
wherein the stopper part attains the dropout prevention state where the nut inserted in the nut insertion part is kept from dropping out in the step of inserting the nut into the nut-holding member; and
wherein the dropout prevention state of the nut is released by screwing a leading end of the bolt into the nut and thereby deforming the stopper part in the bolt-joining step.

9. A bolt-joining method according to claim 8, wherein the stopper part of the nut-holding member has a claw part projecting to the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bending the stopper part having the claw part in the bolt-joining step.

10. A bolt-joining method according to claim 8, wherein the stopper part of the nut-holding member is a claw part projecting to the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bending the claw part in the bolt-joining step.

11. A bolt-joining method according to claim 8, wherein the stopper part of the nut-holding member is constituted by a tilted part forming a side wall of the nut insertion part and overlapping the nut insertion part while tilting toward the bearing surface side of the nut inserted in the nut insertion part; and
wherein the dropout prevention state of the nut is released by screwing the bolt into the nut inserted in the nut insertion part, rotating the bolt so as to move the nut toward a head of the bolt, and thereby bringing the nut into contact with the tilted part and bending the side wall outward in the bolt-joining step.

12. A bolt-joining method according to claim 8, wherein the stopper part of the nut-holding member has a substantially L-shaped form comprising an arm part projecting to the upper surface side of the nut inserted in the nut insertion part and a projection part adapted to be inserted in a screw hole of the nut and engage a screw groove of the screw hole; and
wherein the dropout prevention state of the nut is released by screwing the bolt into the nut inserted in the nut insertion part, causing the leading end of the bolt to push the projection part engaging the screw groove of the nut to outside of the nut, and pushing the projection part out of the screw hole of the nut while bending the arm part in the bolt-joining step.

13. A bolt-joining method according to claim 8, wherein the nut insertion part of the nut-holding member is formed slightly larger than an outer form of the nut, while the nut inserted in the nut insertion part is held loosely to such an extent as to be kept from rotating within the nut insertion part together with the screwing of the bolt.

14. A bolt-joining method according to claim 8, wherein the nut-holding member is formed from a non-foaming synthetic resin or a low- or mid-foaming resin.

15. A nut-holding member according to claim 2, wherein the nut insertion part of the nut-holding member is formed slightly larger than an outer form of the nut, while the nut inserted in the nut insertion part is held loosely to such an extent as to be kept from rotating within the nut insertion part together with the screwing of the bolt.

16. A nut-holding member according to claim 2, wherein the nut-holding member is formed from a non-foaming synthetic resin or a low- or mid-foaming resin.

17. A nut-holding member according to claim 3, wherein the nut insertion part of the nut-holding member is formed slightly larger than an outer form of the nut, while the nut inserted in the nut insertion part is held loosely to such an extent as to be kept from rotating within the nut insertion part together with the screwing of the bolt.

18. A nut-holding member according to claim 3, wherein the nut-holding member is foamed from a non-foaming synthetic resin or a low- or mid-foaming resin.

19. A bolt-joining method according to claim 9, wherein the nut insertion part of the nut-holding member is formed slightly larger than an outer form of the nut, while the nut inserted in the nut insertion part is held loosely to such an extent as to be kept from rotating within the nut insertion part together with the screwing of the bolt.

20. A bolt-joining method according to claim 9, wherein the nut-holding member is formed from a non-foaming synthetic resin or a low- or mid-foaming resin.
